(19) United States
(12) Patent Application Publication
(10) Pub. No.: US 2004/0204959 A1
(43) Pub. Date: Oct. 14, 2004

(54) Exernet system

(76) Inventors: Kenneth J. Moreano, Austin, TX (US); Stephen J. Flora, Batavia, IL (US)

Correspondence Address: Kenneth Moreano, 4402 N. 138th St, Omaha, NE, 68164, US

(21) Appl. No.: 10/308,330

(22) Filed: Dec. 3, 2002

(51) Int. Cl. G06G 7/00; G06F 17/00; G06F 17/60; A63B 1/00

(52) U.S. Cl. 705/2; 705/400; 482/148

(57) ABSTRACT

The Exernet system enables the development of an exercise prescription via the Internet by a medical or healthcare professional, the implementation of safety limits and/or parameters, the delivery of the prescription, and the execution of the exercise prescription directly to a device via the internet and the collection, storage, reporting and presentation of the physiologic data collected from each exercise prescription session. The end user (patient or client) simply logs into the system and presses “start”. The individualized prescription is then executed. The Exernet system also enables the analysis and review of the prescription and physiological data generated by the user and device to be viewed real time or at a later time via the internet for further analysis and adjustment to the prescription. The system also addresses the problems with self-reported data. The Exernet is an automated method of documenting adherence and compliance of the users as well as documenting the proper protocols and prescriptions used in die research, preventative, early detection, rehabilitation, or fitness/wellness environments.

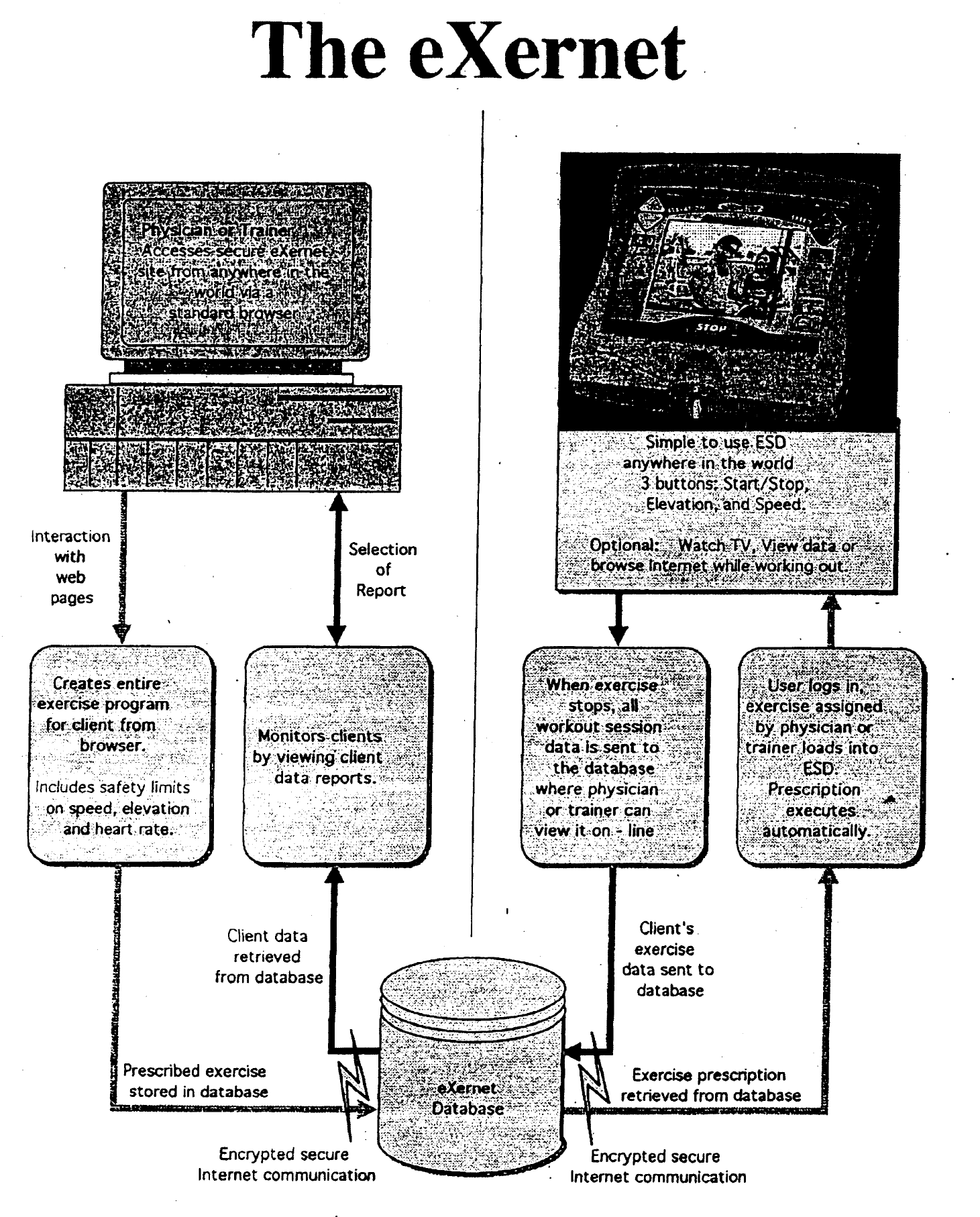

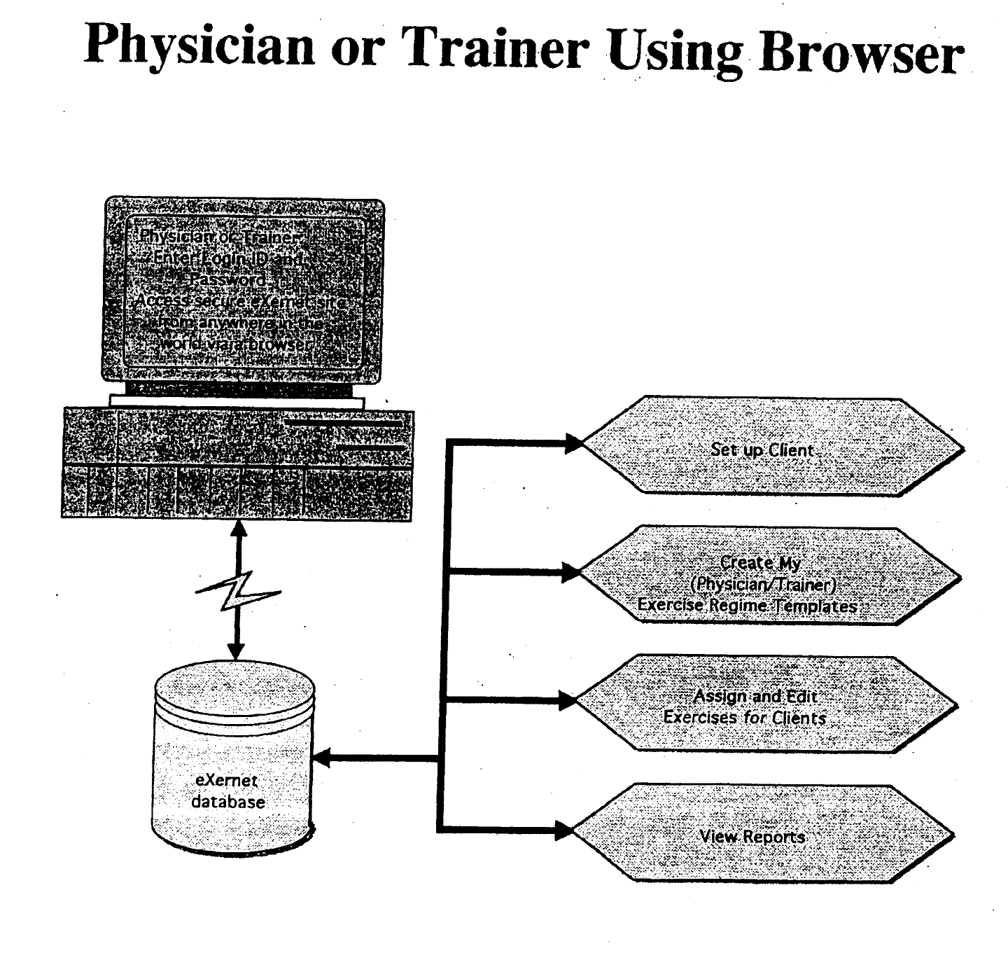

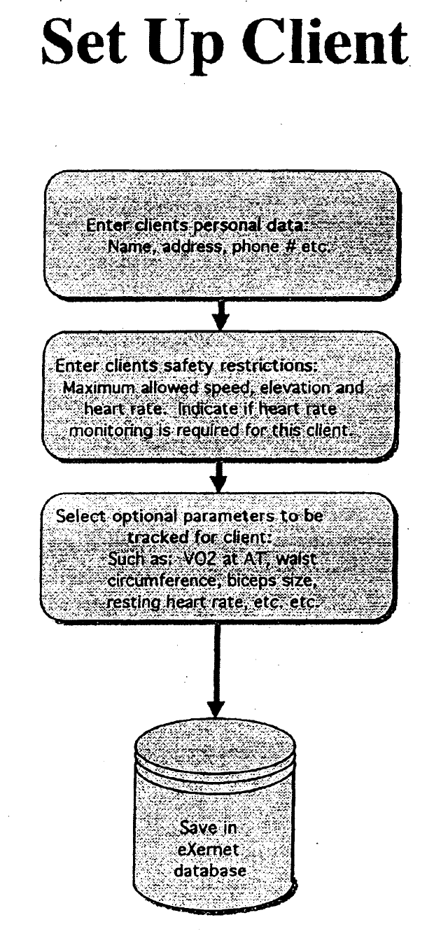

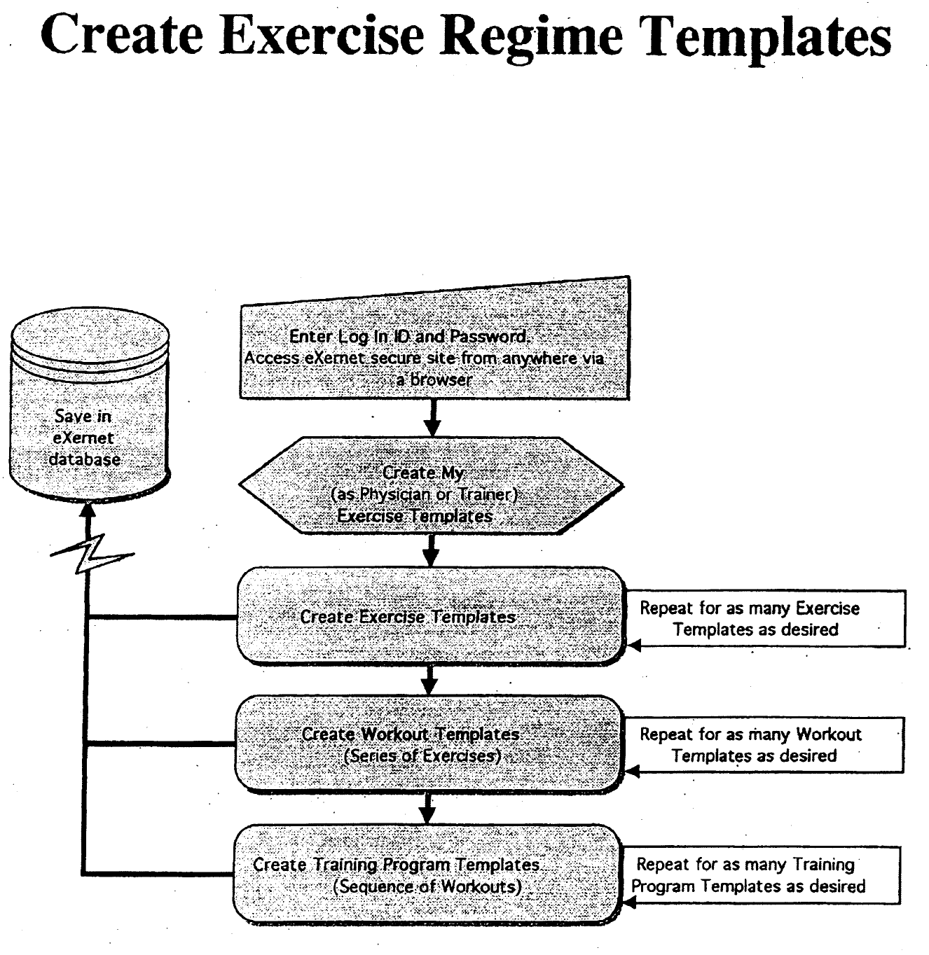

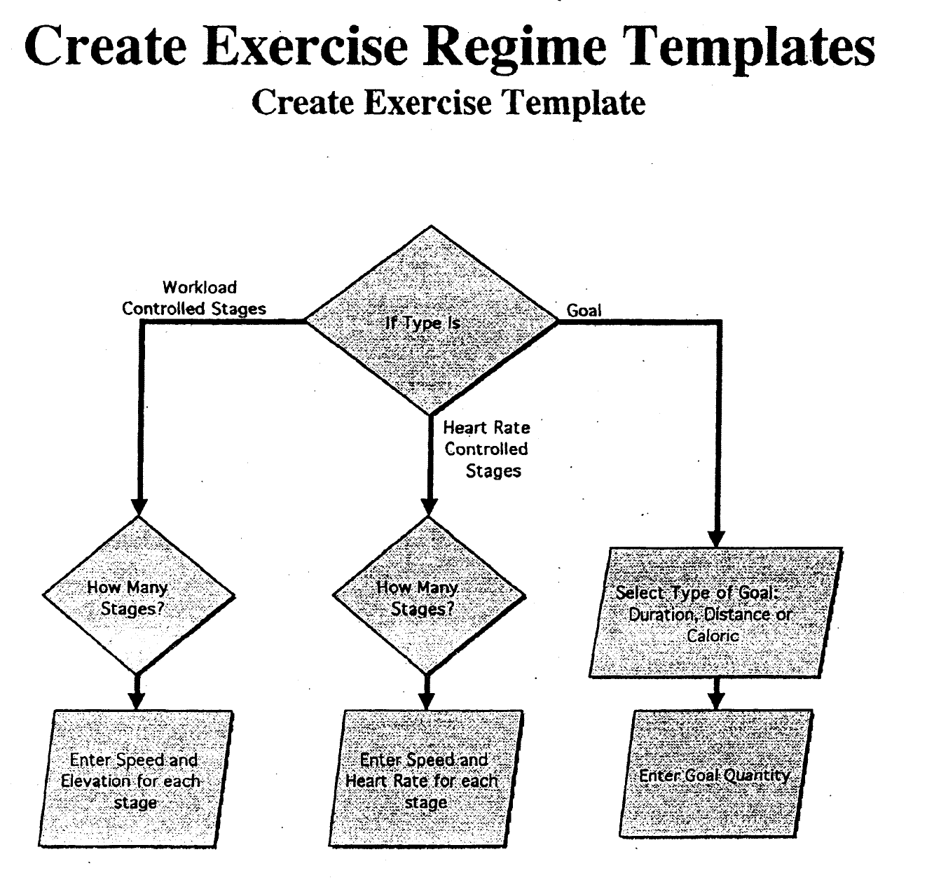

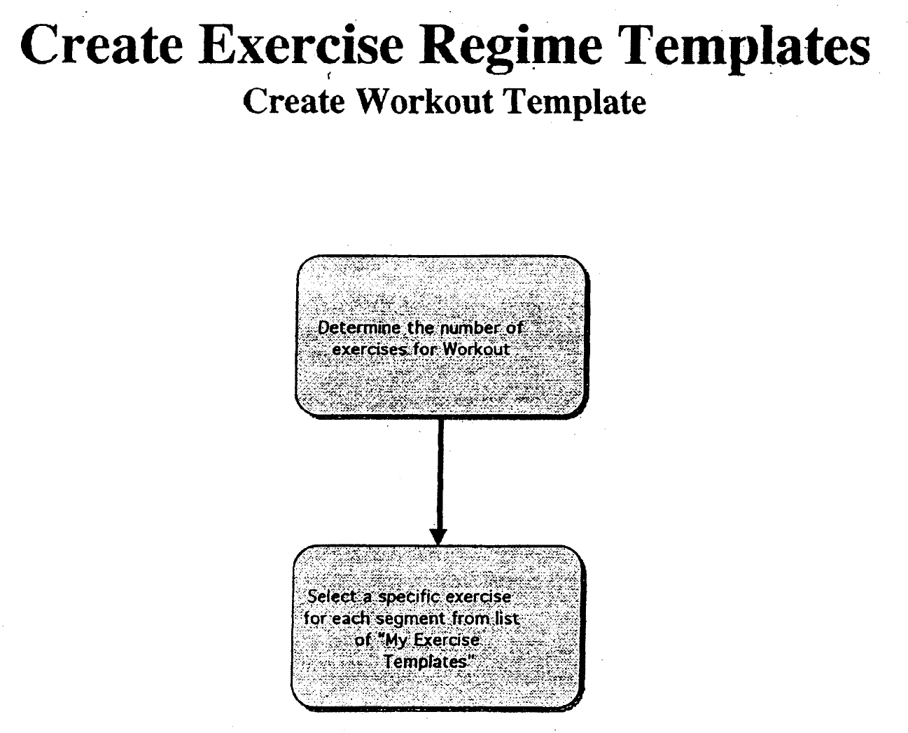

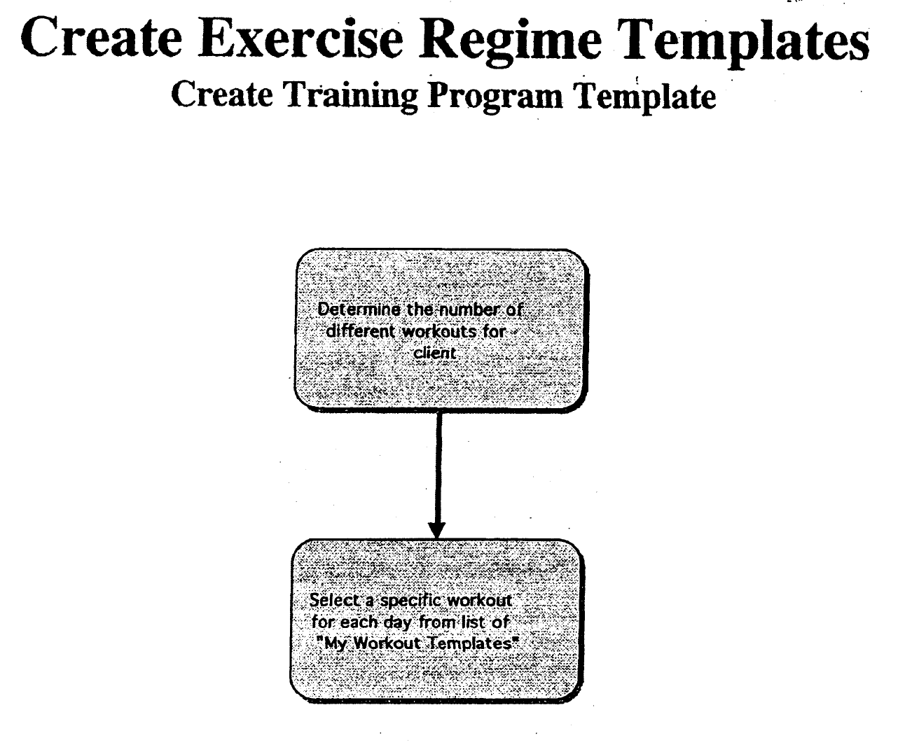

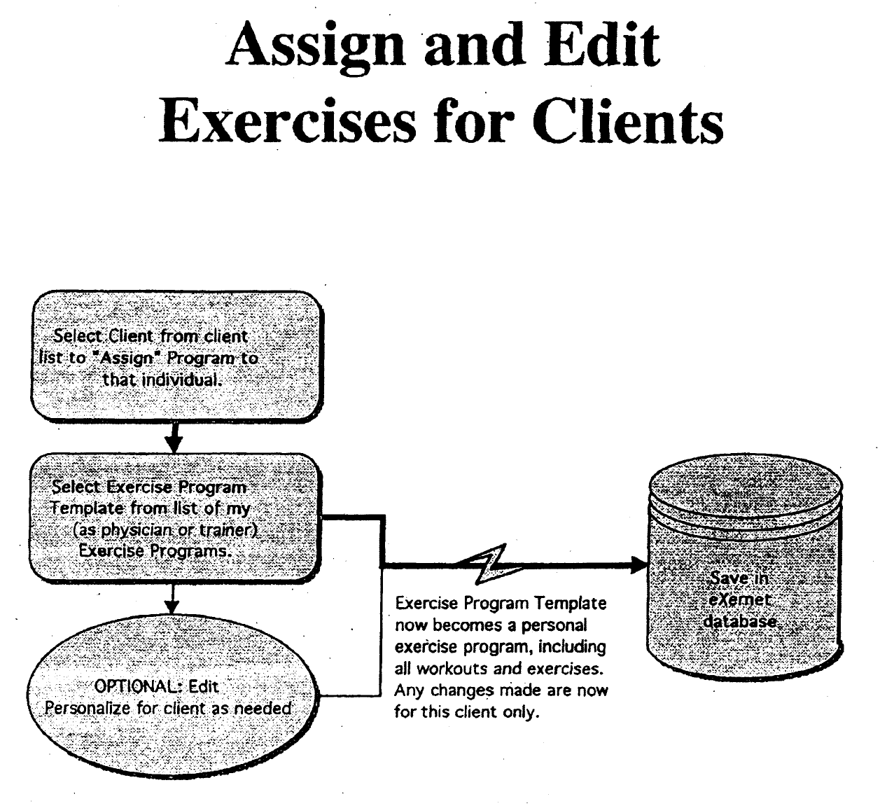

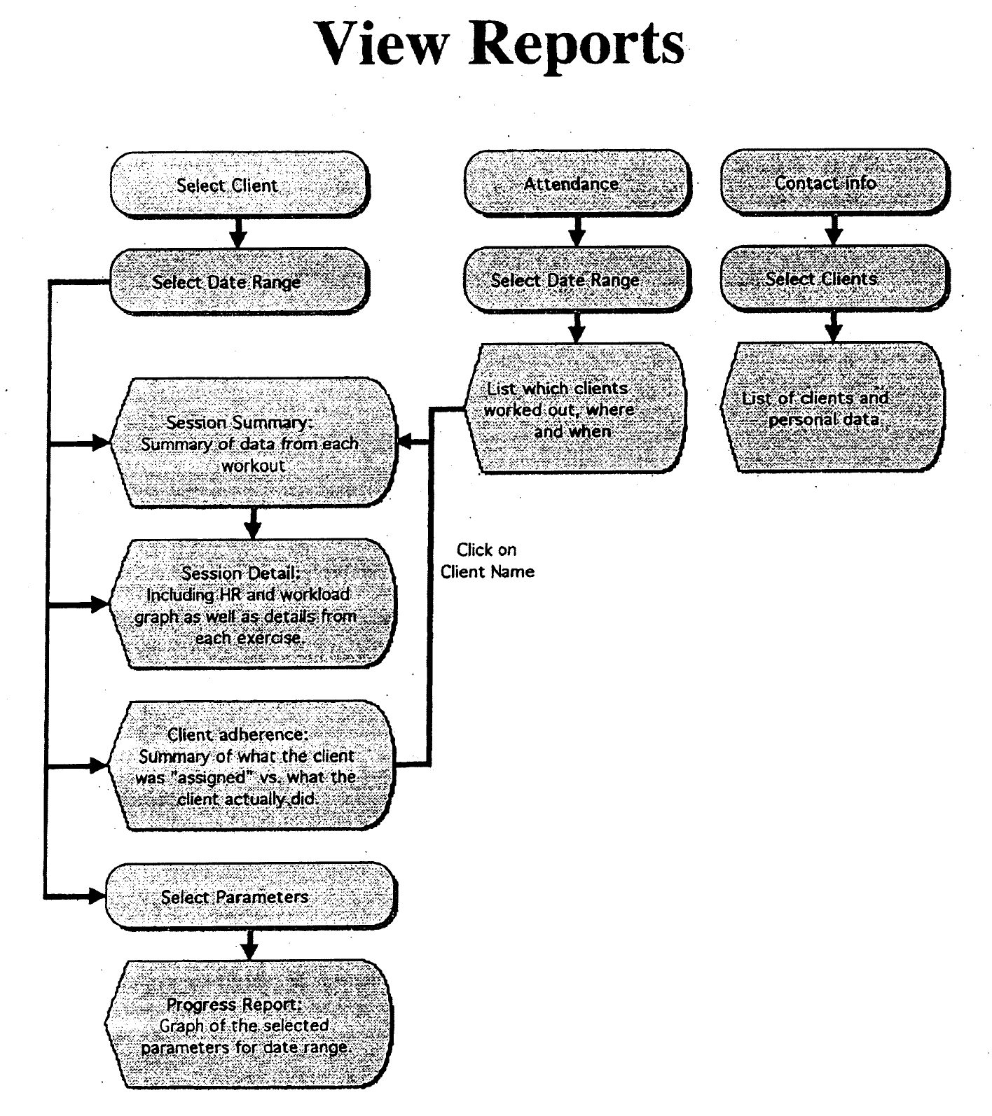

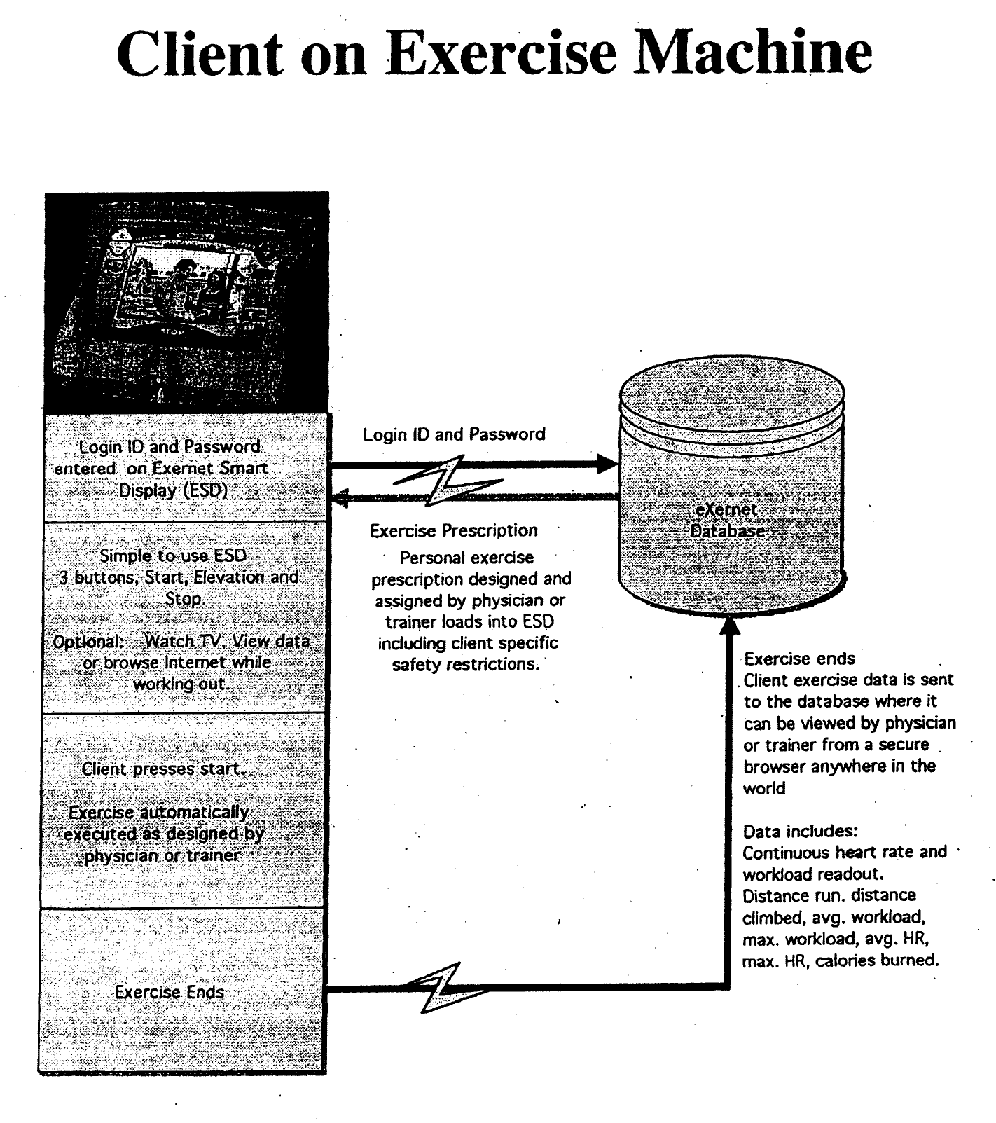

The Exernet system allows a medical or healthcare professional to sit at any computer linked to the internet, develop an exercise regimen specific for their patient or client, and have that same prescription executed on the exercise machine that the patient or client uses. The regimen is sent via the internet directly to the Exernet database where it is available for use. When the user logs in, the system recognizes the user, immediately uploads the workout regimen and executes the regimen directly through the device being used after tie user presses “start” on the touch screen control panel. The system provides remote prescription generation, delivery, execution, and review along with customizable safety parameters, and data collection to support decisions in areas of exercise prescription structure, promotional program participation, adherence and compliance. Example: Your doctor sits at his computer and develops an exercise regimen specifically for you. The regimen is for you to walk on a treadmill for 20 minutes at 3.0 miles per-hour, at 3.0% incline. After the doctor enters this prescription into his computer (actually the exernet system web software platform) it is available for you to use. You then go to a treadmill that has the Exernet computer controller (touch screen) and enter your name and password. The system immediately recognizes you and executes the workout regimen to the device (treadmill). You press “stare” and the regiment is executed. The treadmill automatically goes to 3.0 miles per hour, 3.0% incline and operates for 20 minutes. Once you complete-your regimen (20 minutes) the treadmill stops. The information that is collected from you (heart rate, blood pressure, EKG, and any other physiological parameters requested) and the treadmill (speed, elevation, distance, duration, frequency, and any other information requested) is available for you and/or your doctor or healthcare professional for review. This information is protected by username and password which access abides by HIPAA regulations.

This information is used to adjust the regimen, keep track of adherence and compliance, and also to ensure the safety of the users.

This invention relates to the development, implementation, execution, and reporting of exercise prescriptions via the internet.

### CROSS-REFERENCE TO RELATED APPLICATIONS

Not applicable

### STATEMENT REGARDING FEDERALLY SPONSORED RESEARCH AND DEVELOPMENT

Not applicable

### BACKGROUND OF INVENTION

The problem that the invention (the Exernet system) addresses is the development of an exercise prescription via the internet by a medical or healthcare professional, the implementation of safety limits and/or parameters, the delivery of the prescription, and the execution of the exercise prescription directly to a device via the internet and the collection, storage, reporting and presentation of the physiologic data collected from each exercise prescription session. The end user (patient or client) simply logs into the system and presses “start”. The individualized prescription is then executed. The Exernet system also enables the analysis and review of the prescription and physiological data generated by the user and device to be viewed real time or at a later time via the internet for further analysis and adjustment to the prescription. The system also addresses the problems with self-reported data. The Exernet is an automated method of documenting adherence and compliance of the users as well as documenting the proper protocols and prescriptions used in the research, preventative, early detection, rehabilitation, or fitness/wellness environments.

### SUMMARY

The Exernet system allows a medical or healthcare professional to sit at any computer linked to the internet, develop an exercise regimen specific for their patient or client, and have that same prescription executed on the exercise machine via the patient or client uses. The regimen is sent via the internet, directly to the Exernet database where it is available for use. When the user logs in, the system recognizes the user, immediately uploads the workout regimen and executes the regimen directly through the device being used after the user presses “start” on the touch screen control panel. The system provides remote prescription generation, delivery, execution, and review along with customizable safety parameters, and data collection to support decisions in areas of exercise prescription structure, promotional program participation, adherence and compliance.

### DRAWING FIGURES

The exernet

Physician or trainer using browser

Set up client

Crate exercise regime templates

Create exercise regime templates (create exercise template)

Create exercise regime templates (create workout template)

Create exercise regime templates (create training program template)

Physician or trainer using browser (assign and edit exercises for client)

Physician or trainer using browser (view reports)

Client on exercise machine

### CONCLUSION

The exernet system allows for remote development/design, implementation of prescription including safety limits, execution, data collection, reporting of data, documentation of data, review of prescriptions and data and adjustment of prescriptions. The system uses the internet to accomplish the above. The system provides an opportunity to broaden the scope and reach of any health related professional delivering services related to exercise, preventative, rehabilitative, sports performance, and related exercise prescriptions. The system's data documentation provides compliance and adherence data for multiple applications including prescription adjustments, promotional/incentive program participation statistics, physiological data collections and exercise equipment usage/maintenance data.

The Exernet system can take many forms such as wireless/palm based technology communicating the prescriptions directly to the exercise machine, local server or boot server access and storage for software, data, prescription generation/deliver, and any exercise or related device. As technology advancements are made, the current architecture of the system may be modified or improved upon at a later date. The navigation in the system can also be modified to make the navigation process more intuitive or easier.

I claim:

1. A method of designing, executing, monitoring and reporting activity

2. The method of claim 1 using an exercise ergometer

3. The method of claim 1 using a personal computer interface as the control panel for the exercise ergometer

4. The method of claim 1 using personal computers

5. A method of providing a platform which is able to construct, manage, assign and document exercise prescriptions

6. A method of providing a platform which, a human operator can use to construct, manage, assign, and document exercise prescriptions

7. A method of accessing and storing said prescriptions and data collected through the communication platforms

8. The method of claim 7 using the Internet, intranet, local network, boot server or other communications network.

9. A method of providing a display which is operatively connected to said platform for accessing said prescriptions for execution, monitoring, and reporting activity

10. A method of providing device which is connected to said platform which said operator can review and manipulate prescriptions

11. A method of providing a device which end user can access and participate in said prescription connected to said platform constructed and manipulated by said operator

12. A method of demonstrating healthcare cost reduction

13. A method of providing a system which captures individual and aggregate compliance data

14. A method of providing a system which captures individual and aggregate adherence data

15. A method of providing a system which reports individual and aggregate compliance and adherence data

16. A method of providing a system which compares health care coot data with compliance and adherence data

17. A method of providing a system which reports health care cost data with compliance and adherence data with demonstrated reduction in health care cost as a direct result of compliance and adherence to the system
